(19) United States
(12) Patent Application Publication
(10) Pub. No.: US 2017/0020083 A1
(43) Pub. Date: Jan. 26, 2017

(54) Low Stress Trainer Kit

(71) Applicant: Joseph Paul Piskala, Worcester, MA (US)

(72) Inventor: Joseph Paul Piskala, Worcester, MA (US)

(21) Appl. No.: 14/922,065

(22) Filed: Oct. 23, 2015

Related U.S. Application Data
(60) Provisional application No. 62/178,419, filed on Apr. 9, 2015.

(51) Int. Cl. A01G 9/12

(52) U.S. Cl. CPC A01G 9/12

(57) ABSTRACT

Provided is a kit facilitating the low stress training horticultural technique comprising an elastic band upon which are strung arms of synthetic cord. The elastic band fits around horticultural containers and the arms form loops when pulled through the cord lock. The looped arms may be fitted around the branches of a plant, then tightened and locked to train plant branches down into a horizontal position, causing side growth sites on the plant to develop into a uniform canopy of primary budding sites, thus increasing the quantity and quality of yield while maintaining ease of manipulation of both the growth of individual plants and the spacing of horticultural areas.

### PRIORITY CLAIM

This application claims the priority of U.S. Provisional Application Ser. No. 62/178,419 filed Apr. 9, 2015.

### NOTICE OF FEDERALLY SUPPORTED RESEARCH

Not Applicable.

### BACKGROUND OF THE INVENTION

Low stress training is a term which has both a narrow and broad connotation within the field of plant husbandry. The broad connotation is any technique which physically manipulates the growth of a plant without breaking, pinching or otherwise damaging it. The narrow connotation has come to mean bending and holding down the main stem and/or arms of plant with a naturally upright growth pattern into a horizontal growth pattern, in species where this training will result in secondary side growth growing upward to form primary flowering bodies. To avoid ambiguity, I will henceforth refer to this technique as “horizontal low stress training”.

Horizontal low stress training is pertinent to plants in which the largest and highest potency flowering bodies form on the top of the plant, with lower potency and size flowering bodies forming on correspondingly lower branches of the plant. Horizontal low stress training causes the trained portions of the plant to become bases along which each leafing site turns upward toward the light source to develop into a flowering top, thus creating an even canopy of several primary flowering tops. Horizontal low stress training maximizes the exposure of the leaves and flowers of the plant to airflow and light, thus increasing photosynthesis and reducing the vulnerability of the plant to disease and mold. Horizontal low stress training increases the proportion of the total growth of the plant which is devoted to the formation of primary flowering tops, thus increasing the quantity and quality of harvest yield.

Horizontal low stress training has developed over several years from the “Sea of Green” horticultural technique in which the main stem of a plant whose growth is otherwise unaltered is held down to produce multiple primary flowering tops. Contemporary horizontal low stress training is often combined with pinching technique, which creates several top branches radiating from a short main stem. Horizontal low stress training is typically accomplished by tying branches down with string or twist-ties, by pinning branches down with weights, or by tying branches into position supported by stakes or rods. Such improvised solutions are difficult and time-consuming both to apply and to adjust. Patent U.S. 20140259911 teaches the use of a container around the rim of which are sewn several fixed elastic imps of varying sizes, which hold the branches of a plant in a horizontal position; this invention is a container rather than a kit which may be applied to any container, and its loops are not moveable or adjustable. This is a disadvantage because low stress training can be continuously implemented as the plant branches grow and increase in length only if the point or points at which the branch is held down can be moved to accommodate new growth, thus resulting in even more flowering tops. The non-adjustable loops of U.S. 20140259911 also pose a difficulty in applying such a device to a variety of plant sizes and desired growth patterns.

Another existing patent, U.S. 20130062478, teaches the use of a mobile screen for plant training having a base which can attach to a horticultural container. This device is not specific to horizontal low stress training and its purpose of converting side growth into primary flowering bodies. Additionally, once the plant grows into such a screen, the screen is not easily removable from the plant and therefore impedes free access to and manipulation of all areas of the plant.

There is currently no reusable kit for horizontal low stress training with adjustable arms to allow the grower maximum control over both the growth of each individual plant and the overall maneuverability of multiple plants in a horticultural area.

### SUMMARY OF THE INVENTION

The present invention seeks to overcome the difficulty of implementation and adjustment associated with existing methods and patents for implementing horizontal low stress training technique with potted plants by providing a low stress training kit which fits which features moveable, adjustable arms designed to loop around the branches of a plant and train them into a horizontal position, thus increasing the plant's formation and development of primary flowering sites, resulting in a higher yield.

Another objective of the invention is to provide a reusable kit which can be used with the user's existing equipment and may be easily removed from one container and moved to another.

A further objective of the invention is to promote a more open growth habit in the plant to which it is applied, resulting in greater exposure to light, thus increasing photosynthesis and ultimately yield.

A further objective of the invention is that by virtue of fully moveable and adjustable arms, the present invention allows its user maximum ability to adjust the growth of individual plants and the use of space in the growing area as desired.

The base of the present invention is comprised of an elastic band or cord, onto either end of which complementary halves of a buckle are clamped using tightly fitted metal or plastic rings. This base is designed to be bucked around the rim or top of a horticultural container. In another embodiment of the invention, there is no buckle and the elastic band, which is designed to be stretched and to fit snugly around the rim of a horticultural container, is clamped into a circle with tightly fitted metal or plastic rings. Five or more arms formed of nylon or similar synthetic cord are attached to the elastic band base of the invention by means of loops or rings, allowing the arms to slide along the base freely. Along each arm is threaded a cord lock which allows the arms to form adjustable loops which can then be locked into the desired position by pushing the cord lock button into the locked position, and can be unlocked at any time by pushing the cord lock button into the unlocked position.

The advantages of the design of the present invention include the synthetic and durable material used for the arms, which render the invention less vulnerable to decay in moist or outdoor conditions compared to natural fabrics. The width and texture of the synthetic cord used for the arms is such that it will gently hold the branches and/or stem of a plant without causing damage as occurs when thin strings or ligaments cut into the growth of a plant. The cord lock on each arm is easy to use and adjust. The loops or rings which attach the arms to the elastic base allow for free movement of the arms of the invention, The elastic band and buckle which form the base of the invention allow for ease of application and reuse.

### BRIEF DESCRIPTION OF THE DRAWINGS

FIG. 1 is a view of the reusable low stress trainer kit of the invention;

FIG. 2 is a fragmentary view of one embodiment of the invention, showing a buckle which is clamped to the base of elastic cord and which clips around the rim of a horticultural container;

FIG. 3 is a fragmentary view of the embodiment of the invention of FIG. 1, showing a metallic ring which links the synthetic cord arm to the elastic band base, permitting the user to easily adjust the position of any of the arms along the base.

FIGS. 4A-4D are a sequential progression of fragmentary views showing how the cord of an arm of the invention is threaded through the open cord lock (FIGS. 4A-4B) and how the cord lock may be used to form (FIG. 4C) and fasten (FIG. 4D) a loop suitable for training a plant arm or stem into horizontal position.

FIGS. 5A and 5B show a branch newly trained into a horizontal position by an arm of the present invention and a similar branch after the side growth has developed into primary flowering sites respectively.

FIG. 6 is a front view of an untrained plant in a horticultural container;

FIG. 7 shows a fully developed plant whose arms have been horizontally low stress trained using the present invention, resulting in the formation of an even canopy of primary flowering sites.

### DETAILED DESCRIPTION OF THE INVENTION

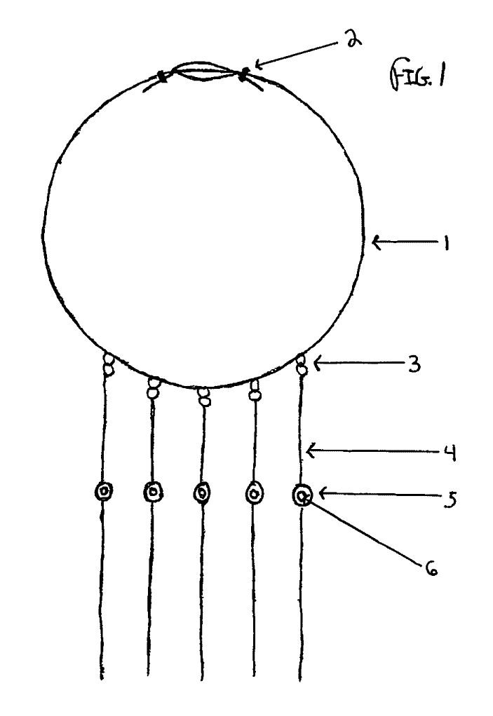

FIG. 1 is an embodiment of the invention in which the elastic base cord, 1, is clamped into a circle with metallic hog rings, 2, in this embodiment, the elastic base cord 1 is threaded through a number of metallic 8 hooks, 3, which corresponds to the number of paracord arms, 4, one of which is tied onto each 8 hook, allowing the arms to slide freely along the base cord. A plastic wheel cord lock, 5, with a lock and release button, 6, is threaded onto each arm, 4.

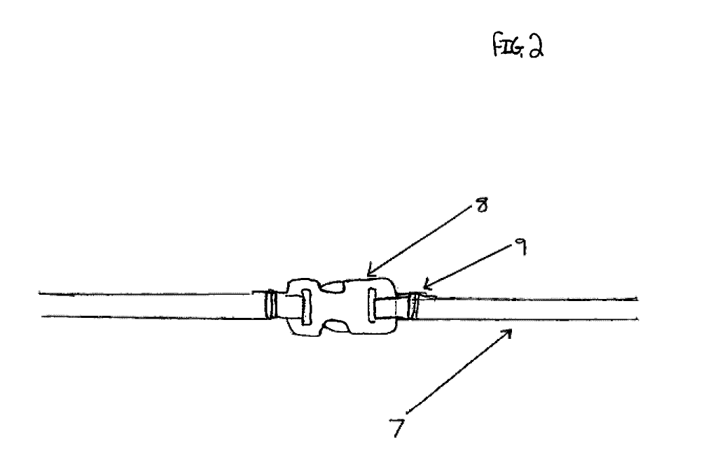

FIG. 2 shows an embodiment of the invention in which a buckle to facilitate application to and removal of the invention from horticultural containers, 8, is damped to either end of the elastic base cord, 7, using plastic rings, 9.

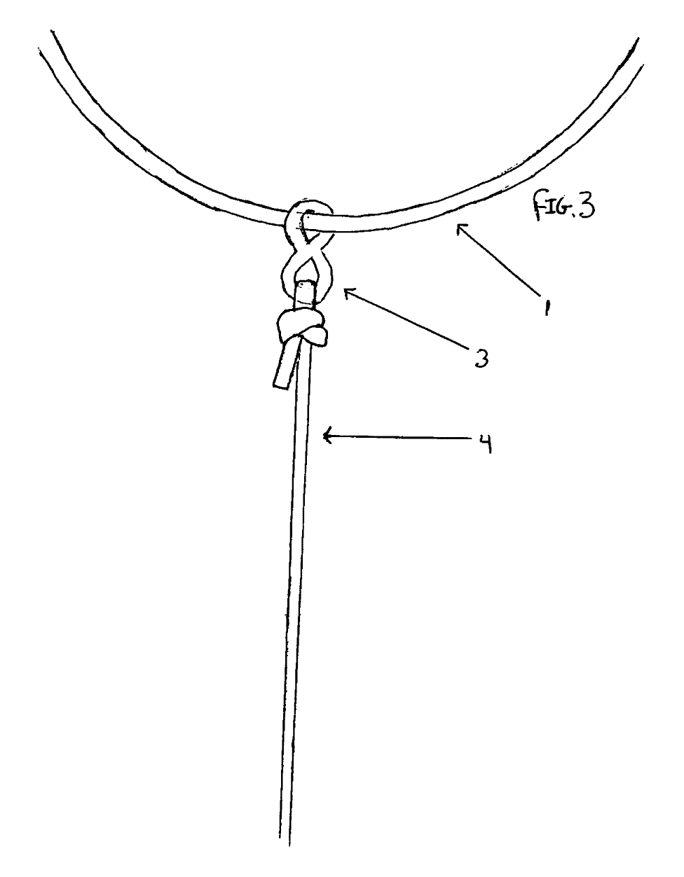

FIG. 3 is a dose up fragmentary view of the embodiment of the invention of FIG. 1, showing how the metallic 8 hook, 3, is threaded onto the elastic base cord, 1, and how the paracord arm, 4, is tied onto the other aperture of the 8 hook, permitting free movement of the arms around the elastic base cord.

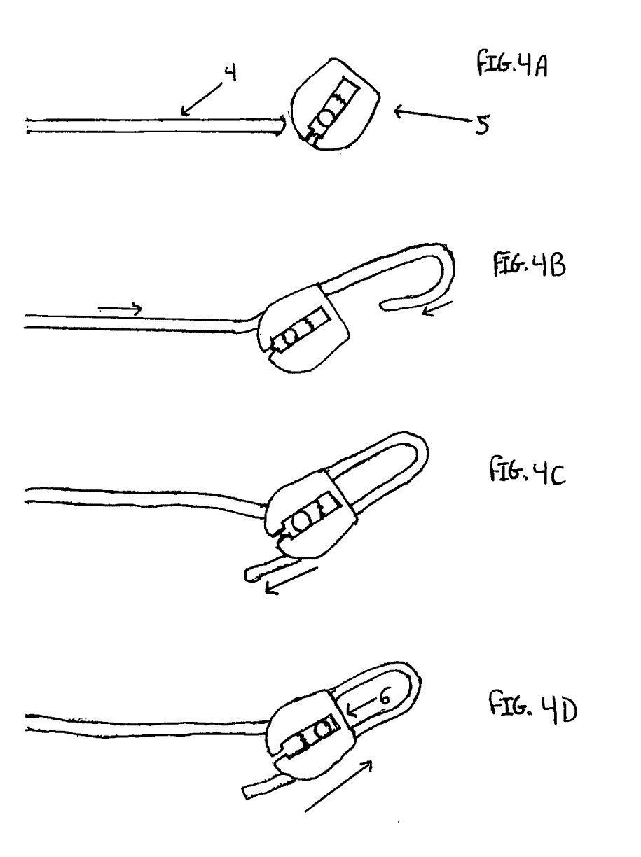

FIGS. 4A-4D are dose up fragmentary views of the embodiment of the invention of FIG. 1, showing how the paracord arm of the invention, 4, is threaded through wheel cord lock, 5. FIG. 4C shows how the user may form a loop with the paracord arm suitable for fitting around the stern of a plant branch. FIG. 4D shows how the locking mechanism of the wheel cord lock may be engaged by pushing the locking mechanism of the cord lock, 6, into the locked position, thus creating a stable yet adjustable loop for plant training.

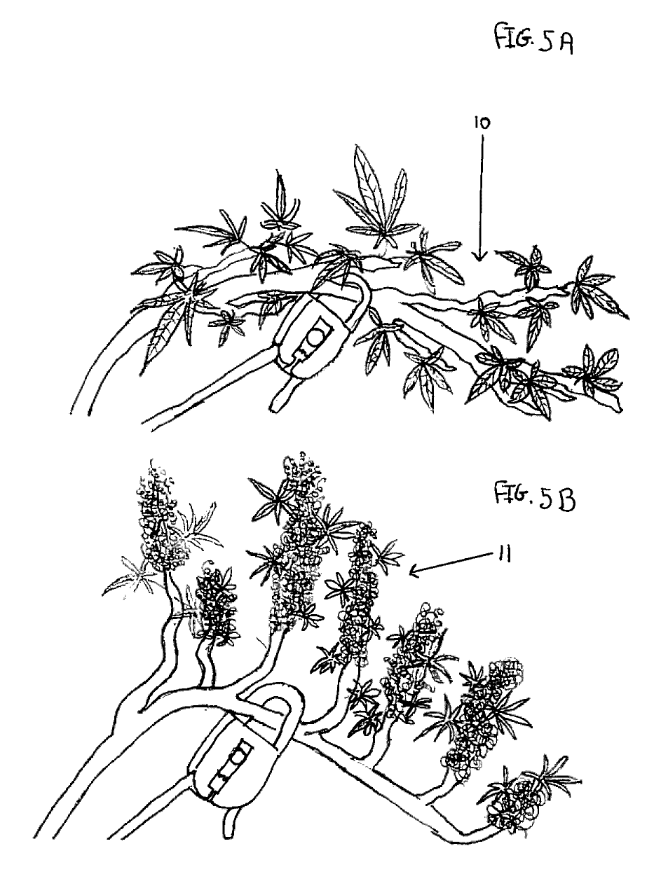

FIG. 5A shows a plant branch, 10, which has been recently trained downwards using an arm of the present invention.

FIG. 5B shows a plant branch, 11, similar the one pictured in FIG. 5A after the secondary side growth has developed into primary flowering colas due to the use of the present invention to implement horizontal low stress training.

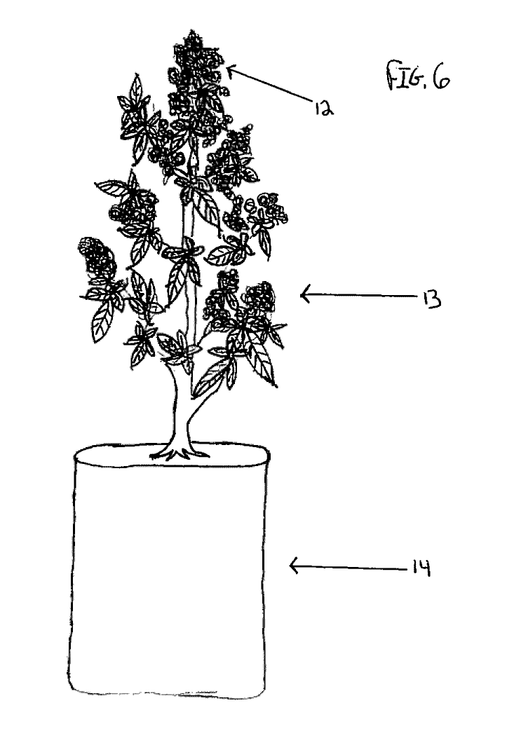

FIG. 6 shows the growth habit of an untrained plant in a horticultural container, 14, in which the primary flowering site at the top of the plant, 22, is superior in size and quality to secondary flowering sites such as 13.

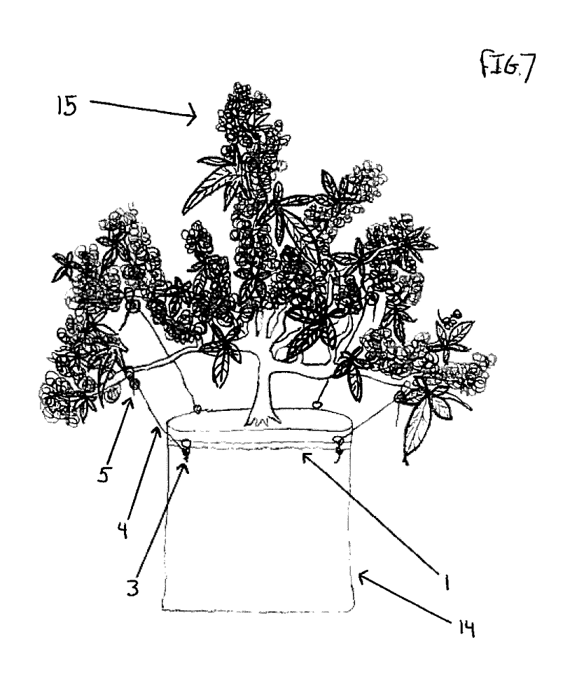

FIG. 7 shows a mature plant, which has benefitted from horizontal low stress training in that it has developed an even canopy of primary flowering sites, 15. The elastic base cord of the present invention, 2, is shown in use around the rim of a horticultural container, 14. The arms of the present invention, 4, are shown in looped position around the arms of the plant, and are locked into piece by means of the cord locks, 5.

1. A reusable kit for implementing low stress training technique, comprising a band which fits around horticultural containers, along which five or more arms of cord are attached by loops or rings, allowing the arms free movement along the band. Each arm has a cord lock which through which the cord of the arm is pulled to form a loop which may be fitted onto a branch of a plant. The loop may then be adjusted and locked with the cord lock to train the branches and/or stem of the plant into a horizontal growth pattern in species where this training results in leafing and secondary budding sites on the plant developing into primary flowering sites, thus increasing yield.

2. The kit of claim 1, wherein the band is formed of shock cord or similar durable elastic material.

3. The kit of claim 2, wherein the arms are formed of cord made from synthetic material such as nylon paracord.

4. The kit of claim 3, wherein the arms are attached to the band with rings, hooks or dips, or are sewn around the band in such a way as to allow free movement of the arms along the band.

5. The kit of claim 4, in which the cord lock is any locking device which may lock or loosen around the cord loop depending on whether a button is manipulated up or down by the user.

6. The kit of claim 5, wherein the band is fastened to complimentary halves of a buckle on either end, allowing the user to buckle the band around a horticultural container.
